(19) United States
(12) Patent Application Publication
(10) Pub. No.: US 2012/0045649 A1
(43) Pub. Date: Feb. 23, 2012

(54) GLASS TREATING METHOD

(75) Inventor: Ronny Pieters, Jumet (BE)

(73) Assignee: AGC GLASS EUROPE, Bruxelles (watermael-Boitsfort (BE)

(21) Appl. No.: 13/318,361

(22) PCT Filed: Jun. 2, 2010
(86) PCT No.: PCT/EP2010/057698

§ 371 Date: Nov. 1, 2011

(30) Foreign Application Priority Data
Jun. 3, 2009 (EP) 09161786.0

(51) Int. Cl. C03C 15/00; B32B 17/00; C03B 25/00

(52) U.S. Cl. 428/410; 216/98; 65/31

(57) ABSTRACT

The present invention discloses a method for treating at least a portion of a surface of a glass article which comprises the following steps, whatever their order: application of a water solution comprising at least one high-pH solid material on said portion of the glass article; heating of said glass article to a temperature at least equal to the evaporation temperature of water.

### FIELD OF THE DISCLOSURE

The present invention relates to a method for treating a surface of a glass article, in particular in order to produce a texture on its surface, for instance a matted, opaque or frosty appearance.

### BACKGROUND OF THE DISCLOSURE

The matting of a glass by etching, especially a glass panel, is normally carried out by treating the surface of the glass with hydrofluoric acid vapor or with etching liquids containing hydrofluoric acid (HF). Unfortunately, due to the high toxicity of HF, the treatment of glass surface can be a dangerous and messy operation.

Attempts to avoid the use of hydrofluoric acid have been developed. For instance, the document GB 1299531 discloses a process which utilizes a solution of an alkali in a mixture of lower alcohol and water.

Unfortunately, the solutions proposed by the state of the art present limitations. The alkaline etching solutions must contain alcohol in order to obtain an adequate spreading of the alkali on the glass surface and also to increase the amount of alkali dissolved in the etching solution. Unfortunately, the use of lower alcohols implies a serious safety issue for use on an industrial line (low flash point, explosion, fire hazard, stocking).

### OBJECTS OF THE INVENTION

It is an object of the present invention, according at least one embodiment, to provide an alternative and safe method, free of fluorine-containing compounds, for treating a solid body, in particular a glass article to produce a matted, opaque or frosty appearance.

A second object of the present invention, according at least one embodiment, is to reduce the energy needed to perform the chemical treatment of the surface.

### SUMMARY

The present invention is directed to a method for treating at least a portion of a surface of a glass article which comprises the following steps, whatever their order:
application of a solution comprising at least one high-pH solid material in water on said portion;
heating of said glass article to a temperature at least equal to the boiling temperature of water.

The term “high-pH solid material” is used to define a solid material providing an increase of the pH when it is dissolved in water. The quantity of high-pH solid materials is such that a pH of at least 8, preferentially 9, more preferably 10 is reached when dissolved in water.

The general term “treating method” is used to describe a method leading to, for instance, an etching or matting or frosting or texturing of the glass surface. The term “application” describes application mode of a solution such as spraying, curtain coating, roller coating. Preferentially, the solution is sprayed.

The inventors have surprisingly found that the use of water as only solvent leads to the same result as a wet process using a mixture of alcohol and water as solvents. The treating method according to the invention offers a safer alternative compared to the prior art due the fact that no alcohol is used.

In an embodiment, the method according to invention is so that the said heating is performed after the said application of solution.

In a preferred embodiment, the method according to the invention is so that the glass article has a temperature at least equal to the melting temperature of said high-pH solid material, said temperature of the glass article directly resulting from a forming process of the glass article.

The inventors have found that the temperature of the glass article immediately after leaving the former machine is high enough to lead to the evaporation of the solvent but also to the melting of the high-pH solid material and therefore be used advantageously due to the fact that no substantial additional energy is needed to perform the chemical etching of the surface.

In an advantageous embodiment, the method according to invention is so that the glass article has a temperature higher than the melting temperature of the high-pH solid material.

A higher temperature of the glass article leads to a more intensive contact between the surface of the glass article and the high-pH solid material which is in a melted state.

In a preferred embodiment, the method according to the invention is so that the glass article has a temperature at least equal to 300° C., preferably at least equal to 500° C., most preferably at least equal to 550° C.

In a preferred embodiment, the method according to the present invention comprises at least a cooling step of the glass article to room temperature after the solution application.

The terms “cooling step” define a step during which the temperature of the glass article finally reaches the ambient temperature at the end of this step.

In a more preferred embodiment, the cooling step includes at least an annealing step.

The annealing temperatures are at least higher than 50° C. at the end of the annealing step. The annealing temperatures are at least lower than 650° C. at the beginning of the annealing step.

In another preferred embodiment, the method according to the present invention comprises a step during which the reaction products resulting from the preceding steps are removed from the surface.

In a preferred embodiment, the method according to the present invention is a texturing method, preferably a matting method

In a particular embodiment, the present invention provides a method in which the glass article is in sheet form.

In a preferred embodiment, the present invention provides a method in which the high-pH solid material comprises at least one salt selected from alkali salts and an earth-alkali salts and mixtures thereof.

The general term “mixture thereof” is used to describe a mixture comprising at least two alkali salts or at least two earth-alkali salts or at least one alkali salt and at least one earth-alkali salt.

In a more preferred embodiment, the at least one salt is selected from hydroxides.

In the most preferred embodiment, the at least one salt is selected from NaOH, KOH and their mixture. Preferably, in such embodiment, the concentration of NaOH or KOH in water is at least equal to 1% in weight, preferably at least equal to 10% in weight, more preferably equal to 25% in weight, the most preferably at least equal to 50% in weight.

Other salts (salts soluble in water: NaCl, KCl, . . . ) could also be used as additives to improve the homogeneous distribution of the solution film on the large hot glass surface (PLF: 6 m×3.21 m). Moreover, these salts (salts soluble in water: NaCl, KCl, . . . ) could also be used to obtain even a wider range of textured surface, as the salts can precipitate during and after the evaporation of the water and provoke an extra non-uniform attack of the glass surface glass surface more or less protected where the salt has precipitated.

When using the embodiment in which the high-pH solid material comprises KOH or is KOH, the inventors have surprisingly found that another technical effect, additional to that of texturing/matting, is obtained. Indeed, they found that a glass article treated with a solution of KOH in water according to the method of the invention is strenghthened, as a glass chemically tempered by a usual manner (immersion during several hours in a bath of a molten potassium salt, like KNO₃).

The present invention provides a glass article having at least one portion of said glass article treated by the method according to any preceding embodiment.

The method according to the invention will be now described in details.

### BRIEF DESCRIPTION OF THE DRAWINGS

FIG. 1 shows a simplified method flow diagram for the production of treated glass according to the present invention

FIG. 2 shows a schematic representation of the glass article obtained according to the present invention.

### DETAILED DESCRIPTION OF THE ILLUSTRATIVE EMBODIMENTS

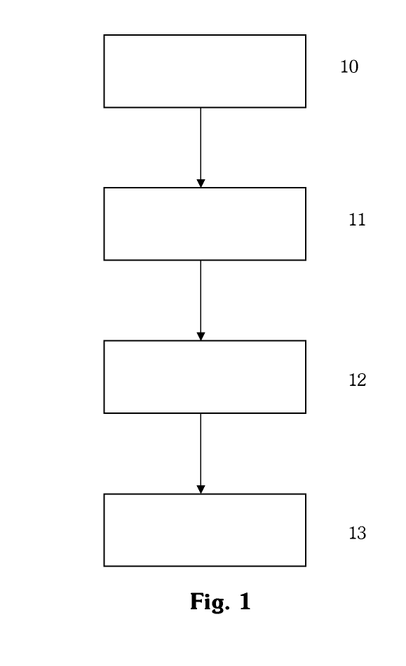

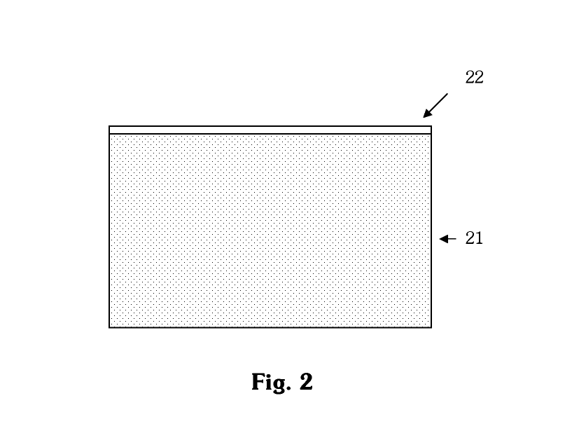

Referring now to the drawings, there are shown preferred embodiments of the method according to the present invention. FIG. 1 shows a simplified scheme of a preferred embodiment of the treating method. A glass article is heated to a temperature at least equal to the boiling temperature of water (10), a water solution comprising at least one high-pH solid material is applied on a least a portion of the glass article (11), after reacting of water solution or even of the melted high-pH solid material if the water is evaporated with the glass surface, the glass/glass surface is cooled down in a controlled way to room temperature with the formation of a crust of the reaction products, (12) and finally the crust formed is removed from the glass (13). FIG. 2 shows a scheme of a glass article obtained after the treating method comprising a glass bulk (21) and a treated surface (22)

A glass surface is textured by applying high-pH aqueous solutions for instance a solution of NaOH, KOH, DOH, CaCO₃, K₂CO₃, Na₂CO₃, Ca(OH)₂, Mg(OH)₂ . . . or a mixture thereof in water and let these aqueous solutions react with the glass surface at temperatures higher than the boiling temperature of water and this without using any fluorine-containing compounds.

The aqueous solutions containing dissolved high-pH solid material in only water are applied on a glass surface. The water is evaporated from the solution on the glass surface during this process and the remaining salt(s) is allowed to texture the glass.

These solutions may be applied on the glass surface:

1—with the glass surface at room temperature during application followed by a temperature increase of the glass or the glass surface to temperatures at least equal to the boiling temperature of water but remaining at temperatures below the melting temperature of the high-pH solid material;

2—with the glass surface at room temperature during application followed by a temperature increase of the glass or the glass surface to temperatures at least equal to the boiling temperature of water and going above the melting temperature of the high-pH solid material;

3—directly at glass surface temperatures below the melting temperature of the high-pH solid material (e.g. 318° C. for NaOH) during application. During and after application, the water is thus evaporated from the solution but remaining at temperatures below the melting temperature of the high-pH solid material; or

4—directly at glass surface temperatures above the melting temperature of the high-pH solid material during application.

Afterwards the glass or the glass surface is cooled down in a controlled way to room temperature with two possibilities:
crust already present after evaporation of water (cases 1 and 3)
with the formation of a crust of reaction products that solidifies below the melting temperature (cases 2 and 4)

The crust is then removed from the glass surface (e.g. by dissolution in water inside a washing machine) and the resulting glass surface is textured, i.e. a rougher surface compared to the original glass surface. The glass texturation results can be obtained on any color or thickness of float glass.

The invention further concerns a glass article with at least one portion of at least one surface of said glass article has been treated by the method according to the invention.

The invention also concerns the use of a glass article treated by the method of the invention for decorative applications. For example, it may be used in furniture, wardrobes, as doors for furniture, as partitions, in tables, shelves, in bathrooms, in shops displays or as wall covering.

Moreover, by a fine-tuning, a new range of possible textured surface is obtained by playing on reaction time, reaction temperature, concentration, additives (e.g. salts, . . . ), amount of applied high-pH solid material per m², combination of several high-pH solid material, . . . so that other properties of the glass surface, e.g. anti-reflective, anti-fog, anti-fingerprinting, anti-fouling, easy-to-clean, anti-glare, are obtained.

The invention also concerns the use of a glass article treated by the method of the invention for solar applications, in particular when antireflective properties are obtained on the treated glass surface. For example, it may be used in solar cells or photovoltaic devices.

The following examples illustrate the invention:

### Example 1

50w % NaOH in water solution applied on 2 mm float glass at room temperature with a bar coater applying a liquid thickness of 100 μm; subsequently dried in an oven at 110° C. during 10 minutes and was afterwards put in a preheated oven at ˜400° C. (above the melting temperature of NaOH) during 5 minutes. The hot glass sample with the NaOH melt on top was taken out of the oven and was left at room temperature to slowly cool down to room temperature. The glass was textured and the resulting roughness parameters are: Rz=3.0 μm, RSm=76.7 μm, Ra=0.45 μm (Ra is the roughness average of peak and valley distances measured along the centerline of one cutoff. RSm is the arithmetic mean value of the width of the roughness profile elements within the sampling length. Rz is the roughness average of the five highest peaks and the five lowest valleys measured in one cutoff length).

### Example 2

50w % NaOH in water solution applied on 2 mm float glass at room temperature with a bar coater applying a liquid thickness of 100 μm; subsequently dried in an oven at 120° C. during 10 minutes and was afterwards put in a preheated oven at ˜400° C. (above the melting temperature of NaOH) during 10 minutes. The hot glass sample with the NaOH melt on top was taken out of the oven and was left at room temperature to slowly cool down to room temperature. The glass was textured and the resulting roughness parameters are: Rz=6.2 μm, RSm=86.8 μm, Ra=0.93 μm.

### Example 3

50w % NaOH in water solution applied on 2 mm float glass at room temperature with a bar coater applying a liquid thickness of 100 μm was afterwards put in a preheated oven at ˜300° C. (below the melting tempearature of NaOH). After the different reaction times at 300° C., the hot glass sample with the NaOH crust on top was taken out of the oven and was left at room temperature to slowly cool down to room temperature. The different reaction times gave rise texturations with the following roughness parameters:

1 minute: Rz=0.27 μm, RSm=1758.9 μm, Ra=0.06 μm

2.5 minutes: Rz=0.36 μm, RSm=620.4 μm, Ra=0.08 μm

10 minutes: Rz=5.05 μm, RSm=436.4 μm, Ra=1.19 μm.

### Example 4

50w % KOH in water solution applied on 2 mm float glass at room temperature with a bar coater applying a liquid thickness of 100 μm was afterwards put in a preheated oven at ˜300° C. (clearly below the melting temperature of pure KOH). After 10 minutes at 300° C., the hot glass sample with the KOH crust on top was taken out of the oven and was left at room temperature to slowly cool down to room temperature. The glass was textured and the resulting roughness parameters are: Rz=5.2 μm, RSm=298.1 μm, Ra=1.0 μm.

### Example 5

25w % KOH in water solution applied on 2 mm float glass at room temperature with a bar coater applying a liquid thickness of 100 μm was afterwards put in a preheated oven at ˜300° C. (clearly below the melting temperature of pure KOH). After 10 minutes at 300° C., the hot glass sample with the KOH crust on top was taken out of the oven and was left at room temperature to slowly cool down to room temperature. The glass was textured and the resulting roughness parameters are: Rz=4.3 μm, RSm=202.0 μm, Ra=1.0 μm.

### Example 6

25w % KOH in water solution with KCl added to the solution was applied on 2 mm float glass at room temperature with a bar coater applying a liquid thickness of 100 μm was afterwards put in a preheated oven at ˜300° C. (clearly below the melting temperature of pure KOH). After 10 minutes at 300° C., the hot glass sample with the KOH-KCl crust on top was taken out of the oven and was left at room temperature to slowly cool down to room temperature. The glass was textured and the resulting roughness parameters are: Rz=7.8 μm, RSm=337.2 μm, Ra=1.4 μm.

### Example 7

25w % KOH in water solution was applied using a simple garden spray system on 2 mm float glass at room temperature and was afterwards put in a preheated oven at ˜300° C. (clearly below the melting temperature of pure KOH). After 10 minutes at 300° C., the hot glass sample with the KOH crust on top was taken out of the oven and was left at room temperature to slowly cool down to room temperature. The glass was textured and the resulting roughness parameters are: Rz=4.1 μm, RSm=435.2 μm, Ra=0.9 μm.

### Example 8

50w % KOH in water solution was applied on 4 mm float glass at room temperature with a bar coater applying a liquid thickness of 100 μm was afterwards put in a preheated oven at ˜575-600° C. After around 5 minutes at ˜575-600° C., the hot glass sample was taken out of the oven and was left at room temperature to cool down to room temperature. The glass was textured and the resulting roughness parameters are: Rz=7.0 μm, RSm=238.1 μm, Ra=1.2 μm.

### Example 9

50w % NaOH in water solution was applied on 4 mm float glass at room temperature with a bar coater applying a liquid thickness of 100 μm was afterwards put in a preheated oven at ˜575-600° C. After around 5 minutes at ˜575-600° C., the hot glass sample was taken out of the oven and was left at room temperature to cool down to room temperature. The glass was textured and the resulting roughness parameters are: Rz=9.2 μm, RSm=1182.5 μm, Ra=2.1 μm.

### Example 10

A 40w % K₂CO₃-sesquihydrate in water solution was applied on 2 mm float glass at room temperature with a bar coater applying a liquid thickness of 100 μm and was afterwards put in a preheated oven at ˜300° C. (below the melting temperature of K₂CO₃-sesquihydrate). After 10 minutes at 300° C., the hot glass sample with the crust on top was taken out of the oven and was left at room temperature to slowly cool down to room temperature. After removing of this crust, the sample had a hazy aspect.

### Example 11

Direct application on the float line at ˜600° C. is performed, a fixed Airmix spray with an atomizing nozzle (atomizing air pressure of ˜10 bar and a liquid flow rate of ˜10 kg/h aqueous alkaline solutions to apply roughly ˜50-100 ml/m² of solution on the glass surface (depending on the speed of the line) is used 1%, 5%, 10%, 25% or 50% in weight of NaOH or KOH or a mixture thereof.

After removing the crust, the samples show a textured surface, more pronounced upon increasing concentration.

When using KOH, properties of strengthening have further been evidenced, additionnally to texturation:

Samples obtained with 25% and 50% in weight of KOH show a surface enrichment in K⁺ ions as determined by X-ray fluorescence. Values of 273 and 275 kcoups/seconde have been measured respectively and these values have to be compared with values generally obtained for classically chemically tempered glass. As illustration, a glass immersed during 8 hours in a molten bath of KNO₃ reaches an average value of 270 kcoups/seconde for potassium ions.

Moreover, diffusion profiles of potassium in a very thin thickness from the surface of the glass (measured by EPMA-WDS) of both samples according to the invention are very close (concentration, depth) to profiles known for classically chemically tempered glass.

Finally, a mechanical resistance test, the so-called circular ring on ring bending test according to the European standard EN 1288-5, has been conducted on the sample treated with a 20 wt. % KOH solution. It has revealed that the mechanical resistance of the sample (maximum stress allowed with an acceptable failure probability of 5%: 214 MPa) is significantly greater than that of a non-treated glass (“float” glass: 80 MPa), even if it is lower than that of a classically chemically tempered glass (340 MPa).

The present invention is not limited to the example mentioned above. In particular the skilled person can make adjustments of parameters as for example the temperature at the end of the annealing lehr and the length of the annealing lehr. For example, the temperature at the end of the annealing lehr is in the range if 50 to 150° C. and the length of the annealing lehr may vary from 110 to 180 m.

1. A method for treating at least a portion of a surface of a glass article, comprising, in any order:
applying a solution comprising at least one high-pH solid material in water on the portion; and
heating the glass article to a temperature at least equal to a boiling temperature of water.

2. The method of claim 1, wherein the heating is after applying the solution.

3. The method of claim 1, wherein the glass article is heated to a temperature at least equal to a melting temperature of the high-pH solid material, and
the temperature of the glass article results directly from a forming process of the glass article.

4. The method of claim 1, wherein the glass article is heated to a temperature higher than a melting temperature of the high-pH solid material.

5. The method of claim 1, wherein the glass article is heated to a temperature at least equal to 300° C.

6. The method of claim 1, further comprising cooling the glass article to room temperature after applying the solution.

7. The method of claim 6, wherein the cooling comprises annealing.

8. The method of claim 1, further comprising removing a reaction product from the surface after applying the solution.

9. The method of claim 1, wherein the glass article is a sheet.

10. The method of claim 1, wherein the high-pH solid material comprises at least one salt selected from the group consisting of an alkali salt, an earth-alkali salt, and mixtures thereof.

11. The method of claim 10, wherein the at least one salt is a hydroxide.

12. The method of claim 11, wherein the at least one salt is NaOH, KOH, or a mixture thereof.

13. The method of claim 12, wherein a concentration of the at least one salt in water is at least equal to 1% by weight.

14. A glass article comprising at least one portion treated by the method of claim 1.

15. The method of claim 1, wherein the glass article is a decorative or solar glass article.

16. The method of claim 1, wherein the glass article is heated to a temperature at least equal to 500° C.

17. The method of claim 1, wherein the glass article is heated to a temperature at least equal to 550° C.

18. The method of claim 12, wherein a combined concentration of NaOH and KOH in water is at least equal to 10% by weight.

19. The method of claim 12, wherein a combined concentration of NaOH and KOH in water is at least equal to 25% by weight.

20. The method of claim 12, wherein a combined concentration of NaOH and KOH in water is at least equal to 50% by weight.
